(19) United States
(12) Patent Application Publication
(10) Pub. No.: US 2013/0017322 A1
(43) Pub. Date: Jan. 17, 2013

(54) METHOD FOR FORMING AN INDIUM (III) SULFIDE FILM

(71) Applicants: Chung-Shin WU, Kaohsiung City (TW); Yu-Yun Wang, Hualien County (TW); Pei-Sun Sheng, Taipei City (TW)

(72) Inventors: Chung-Shin WU, Kaohsiung City (TW); Yu-Yun Wang, Hualien County (TW); Pei-Sun Sheng, Taipei City (TW)

(21) Appl. No.: 13/304,534

(22) Filed: Nov. 25, 2011

(30) Foreign Application Priority Data
Jul. 12, 2011 (TW) 100124552

(51) Int. Cl. B05D 5/00; B05D 1/18

(52) U.S. Cl. 427/126.1

(57) ABSTRACT

An embodiment of the invention provides a method for forming an indium (III) sulfide film, including providing a mixed solution containing a complexing agent, indium ions, and hydrogen sulfide ions; and contacting the mixed solution with a substrate to form an indium (III) sulfide film thereon, wherein the complexing agent has the following formula:

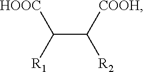

wherein each of R₁ and R₂ respectively is hydrogen or hydroxyl.

### CROSS REFERENCE TO RELATED APPLICATIONS

This application claims priority of Taiwan Patent Application No. 100124552, filed on Jul. 12, 2011, the entirety of which is incorporated by reference herein.

### BACKGROUND OF THE INVENTION

1. Field of the Invention

The present invention relates to forming an indium (III) sulfide film, and in particular relates to a method for forming the indium (III) sulfide film by a chemical bath deposition.

2. Description of the Related Art

A buffer layer, which plays an important role in a thin film solar cell, can combine with an absorbent layer to form a p-n junction, thereby facilitating electron transfer to fully convert light into electricity.

Since 1982 Boeing Company developed a chemical bath deposition (CDB), it became a well-known technique for preparing a thin film Advantages of the technique include easy preparation, low cost, and good film quality, which make it suitable for forming a buffer layer in a thin film solar cell.

Two kinds of nucleation mechanisms are involved in a chemical bath deposition process, including homogeneous nucleation and heterogeneous nucleation. In a heterogeneous nucleation mechanism, an anion and a cation form a nucleus at a heterogeneous interface. Then, ions are subsequently stacked on the nucleus and undergo a chemical reaction to form a thin film on the heterogeneous interface. On the other hand, in a homogeneous nucleation mechanism, anions and cations directly form nuclei in the solution. Then, nuclei stacked on one another and undergo a chemical reaction to form particulate suspension in the solution.

In general, when chemical bath deposition is used to form a buffer layer of a thin film solar cell, HS⁻ ions are reacted with metal ions to deposit a metal sulfide thin film on a substrate. Conventionally, thiourea, as a source of the HS⁻ ions, will release HS⁻ ions only when reacting with OH⁻ in a basic condition. When thiourea is in an acidic condition, S²⁻ ions will be released instead of HS⁻ ions. Therefore, chemical bath deposition has to be performed in a basic condition in order to form the buffer layer. However, if the metal ions used tend to form insoluble metal hydroxide under basic condition, the desirable metal sulfide thin film can not be formed by the chemical bath deposition.

Cadmium sulfide (CdS) is commonly used as a buffer layer of a thin film solar cell. However, since Cd is heavy metal, it is harmful for human health and the environment. Therefore, development of new buffer layer material without Cd is required. Indium (III) sulfide (In₂S₃) is recently used as a buffer layer material containing no Cd. Indium (III) sulfide film can be formed by such as atomic layer deposition (ALD), evaporation, sputtering, or the like. However, a vapor-phase preparation usually requires to be performed in vacuum at high temperature, which may damage the topography of the thin film.

Accordingly, a method for forming a buffer layer which is easy to perform, low cost, and low toxicity and suitable for mass production is required.

### BRIEF SUMMARY OF THE INVENTION

An embodiment of the invention provides a method for forming an indium (III) sulfide film, including providing a mixed solution containing a complexing agent, indium ions, and hydrogen sulfide ions; and contacting the mixed solution with a substrate to form an indium (III) sulfide film thereon, wherein the complexing agent has the following formula:

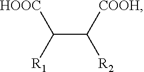

wherein each of R₁ and R₂ respectively is hydrogen or hydroxyl.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is cross section of a conventional thin film solar cell.

FIGS. 2-4 are SEI diagrams of indium (III) sulfide film according to various examples of the invention.

FIG. 5 illustrates a relationship between voltage and current density of a CIGS battery according to one example of the invention.

FIG. 6 is an SEI diagram of indium (III) sulfide film according to one example of the invention.

FIG. 7 is a Raman spectrum of indium (III) sulfide film according to one example of the invention.

FIGS. 8-13 illustrate SEI diagrams of indium (III) sulfide film and relationships between voltage and current density of CIGS batteries according to various comparative examples of the invention.

FIG. 14 is a Raman spectrum of indium (III) sulfide film according to varios examples and comparative examples of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Moreover, the formation of a first feature over and on a second feature in the description that follows may include embodiments in which the first and second features are formed in direct contact, and may also include embodiments in which additional features may be formed between the first and second features, such that the first and second features may not be in direct contact.

In one embodiment of the invention, a method for forming an indium (III) sulfide film is provided. The method requires short reaction time, low reaction temperature, and low cost, and the resulting film has high quality and low toxicity. Therefore, the method is suitable for industrial use. For example, the method can be used to prepare a buffer layer of a copper indium gallium diselenide (CIGS) thin film solar cell.

First, a mixed solution containing a complexing agent, indium ions, and hydrogen sulfide ions is provided. For example, a complexing agent may be added into a solution. Then, indium ions and hydrogen sulfide ions may be then added into the solution to form a mixed solution. Next, the mixed solution may be in contact with a substrate at room temperature or at an elevated temperature to form an indium (III) sulfide film thereon.

The complexing agent may have the following formula:

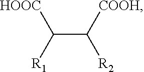

wherein each of R₁ and R₂ respectively is hydrogen or hydroxyl. Examples of the complexing agents include tartaric acid, succinic acid, or combinations thereof.

The complexing agent has two carboxylic groups in the structure to chelate with ions in the solution. In general, the complexing agent is selected to match with a size of the ion in order to chelate with the ion. Therefore, different ions require different complexing agents to chelate with. The inventors of the present invention discover that for indium ions, a suitable complexing agent should have two carboxylic groups in the structure with exactly two carbons in between, such that a distance between the two carboxylic groups can match with the size of the indium ions, and therefore the complexing agent can have good chelating ability toward indium ions. If the distance between the two carboxylic groups is about only one carbon atom, such as malonic acid, the distance between the two carboxylic groups is so small that the complexing agent can not chelate with an indium ion. On the other hand, if the distance between the two carboxylic groups is larger than a distance of about two carbons, such as the structure of citric acid, the distance between the two carboxylic groups is so large that the two carboxylic groups can rotate freely. As such, it is difficult for the complexing agent to chelate with the indium ions, and the complexing agent does not have good chelating ability with indium ions.

Metal salts containing indium can be added to the solution used as an indium ion source. Examples of the metal salts include, but are not limited to, indium (III) sulfate (In₂(SO₄)₃), indium trichloride (InCl₃), indium (III) acetate (In(C₂H₃O₂)₃), or any other salts that release indium ions when dissolved in water, or combinations thereof. Moreover, thioacetamide can be used as a hydrogen sulfide ion source and is added into the solution. A pH value of the mixed solution may be between 1 and 3. In one embodiment, the complexing agent, the indium ions, and the hydrogen sulfide ions in the mixed solution are present in a ratio of 0.01M-0.5M:0.025M-0.1M:0.01M-1M.

After the mixed solution containing the complexing agent, the indium ions, and the hydrogen sulfide ions is prepared, an indium (III) sulfide film is deposited on various substrates by chemical bath deposition, wherein the substrates include, but are not limited to, a copper indium gallium diselenide (CIGS) substrate. The reaction temperature for the chemical bath deposition process is not limited, but may range from 25° C. to 80° C. A thickness of the indium (III) sulfide film may be adjusted depending on particular requirements of applications. When the indium (III) sulfide film is used in a copper indium gallium diselenide thin film solar cell, the thickness of the indium (III) sulfide film may range from 20 nm to 100 nm.

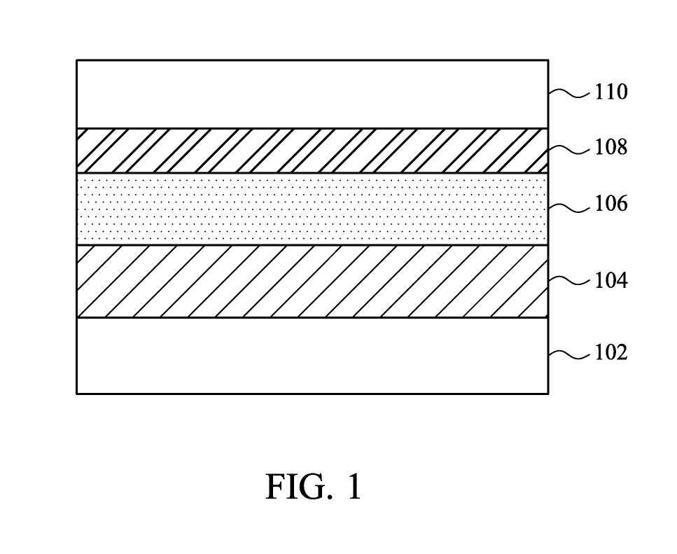

FIG. 1 is a cross section view of a conventional thin film solar cell. As shown in FIG. 1, a thin film solar cell includes a substrate 102. Then, a back electrode 104, a CIGS absorbent layer 106, an indium (III) sulfide buffer layer 108, and a transparent conductive layer 110 are subsequently formed on the substrate 102. The substrate 102 may include glass, polymers, or metal substrates. The back electrode 104 may include molybdenum (Mo). The transparent conductive layer 110 may include zinc oxide (ZnO).

In one specific embodiment, the substrate 102 with the back electrode 104 and the CIGS absorbent layer 106 formed thereon is immersed into the mixed solution described above to form the indium (III) sulfide buffer layer 108. The indium (III) sulfide buffer layer 108 of the embodiment has a planar, compact surface, and therefore can provide better reliability when used in a solar cell.

In general, during the chemical bath deposition process, there are two kinds of nucleation mechanisms, including homogeneous nucleation and heterogeneous nucleation. When the complexing agent has good chelating ability with the indium ion, such as the complexing agent has a structure of two carboxylic groups with exactly two carbons in between, the indium (III) sulfide film will tend to form in a heterogeneous nucleation mechanism. That is, in the solution, a hydrogen sulfide ion will first bond to an indium ion chelated with a complexing agent. Then, the complexing agent leaves the indium ion while another hydrogen sulfide may then bond to the above indium ion, and the same procedures are repeated. Accordingly, in a heterogeneous nucleation mechanism, thin film is formed gradually by one ion bonding to another, then another, and goes on. Therefore, the reaction state has an order om short term but disorder in long term. Thus, the resulting thin film has an amorphous state. This kind of indium (III) sulfide film has a planar surface, and therefore when used as a buffer layer of a thin film solar cell, the indium (III) sulfide film can attach to the transparent conductive layer securely without unwanted voids formed therebetween.

However, when the complexing agents do not have good chelating ability with the indium ions, such as the two carboxylic groups of the complexing agent have more/less than two carbons in between, the indium (III) sulfide film will tend to be formed in a homogeneous nucleation mechanism. That is, since the complexing agents do not have good chelating ability with indium ions, a great amount of indium ions arc freely released in the solution. The free indium ions and hydrogen sulfide ions may rapidly bond together to form indium (III) sulfide particles. Then, the formed indium (III) sulfide particles may stack on one another to form a crystalline indium (III) sulfide film. The crystalline indium (III) sulfide film has acicular surface, and therefore when used as a buffer layer of a thin film solar cell, the uneven surface of the indium (III) sulfide film will result in many unwanted voids in the cell, leading to high resistance.

In addition, when the complexing agents do not have good chelating ability with indium ions, some of the free indium ions may react with OH⁻ in the solution to from precipitated indium hydroxide instead of forming pure indium (III) sulfide. The indium hydroxide will affect the energy gap of the resulting indium (III) sulfide film. The more the indium hydroxide is formed, the higher the energy gap is. Therefore, the energy gap of the resulting indium (III) sulfide film may not match with the CIGS absorbent layer and may result in a heterointerface as a defect, and thus adversely affecting battery performance and leading to lower transmittance and higher resistance. Conventionally, acid, such as HCl, is added into the solution to neutralize the hydroxyl group to avoid the formation of the hydroxide may be avoided.

However, since the complexing agents of the invention have good chelating ability with indium ions, there won't be many free indium ions in the solution. Therefore, in the invention, the formation of the hydroxide can be avoided even if no acid is added into the solution for controling the pH value, and a high purity indium (III) sulfide film can be obtained.

### Example 1

First, tartaric acid was added into deionized water as a complexing agent, and the solution was stirred until the tartaric acid was completely dissolved. Next, In₂(SO₄)₃ was added into the solution as an indium ion source, and the solution was stirred until the In₂(SO₄)₃ was completely dissolved. Then, a SC(NH₂)(CH₃) solution was added into the solution described above and the mixed solution containing the complexing agents, the indium ions, and the hydrogen sulfide ions was stirred throughly. The complexing agent, the indium ions, and the hydrogen sulfide ions in the mixed solution were presented in a ratio of 0.008M:0.1M:0.04M. The mixed solution was placed into a reactor.

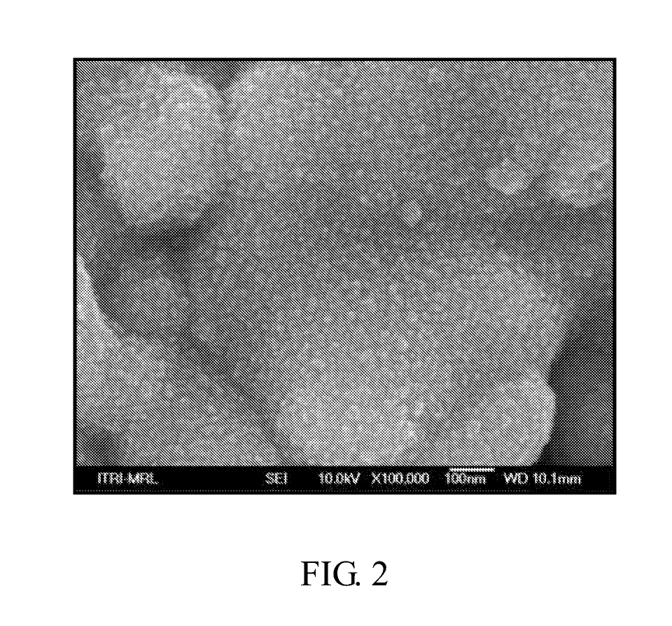

A printing CIGS layer was used as a substrate and was sunk into the mixed solution with its face down. The reactor was capped and heated in water bath at a temperature of 65° C. for 105 minutes to give a yellow indium (III) sulfide film. The indium (III) sulfide film formed on the CIGS layer had a coverage rate over 99%, and a thickness of about 30 nm. FIG. 2 is a secondary electron image (SEI) diagram of the indium (III) sulfide film that formed.

### Example 2

First, tartaric acid was added into deionized water as a complexing agent, and the solution was stirred until the tartaric acid was completely dissolved. Next, In₂(SO₄)₃ was added into the solution as an indium ion source, and the solution was stirred until the In₂(SO₄)₃ was completely dissolved. Then, a SC(NH₂)(CH₃) solution was added into the solution described above and the mixed solution containing the complexing agents, the indium ions, and the hydrogen sulfide ions was stirred evenly. The complexing agent, the indium ions, and the hydrogen sulfide ions in the mixed solution are presented in a ratio of 0.008M:0.1M:0.24M. The mixed solution was placed into a reactor.

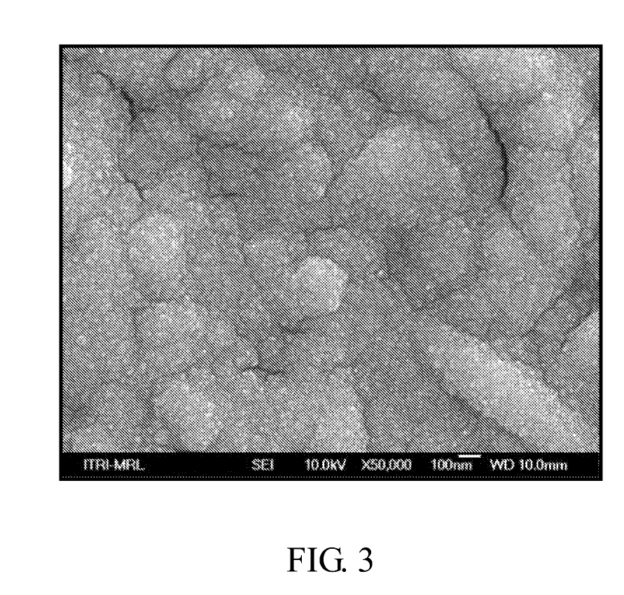

A printing CIGS layer was used as a substrate and was sunk into the mixed solution with its face down. The reactor was capped and heated in water bath at a temperature of 65° C. for 45 minutes to give a yellow indium (III) sulfide film. The indium (III) sulfide film formed on the CIGS layer had a coverage rate over 99%, and a thickness of about 50 nm-100 nm. FIG. 3 is a secondary electron image (SEI) diagram of the formed indium (III) sulfide film that formed.

### Example 3

First, tartaric acid was added into deionized water as a complexing agent, and the solution was stirred until the tartaric acid was completely dissolved. Next, In₂(SO₄)₃ was added into the solution as an indium ion source, and the solution was stirred until the In₂(SO₄)₃ was completely dissolved. Then, a SC(NH₂)(CH₃) solution was added into the solution described above and the mixed solution containing the complexing agents, the indium ions, and the hydrogen sulfide ions was stirred evenly. The complexing agent, the indium ions, and the hydrogen sulfide ions in the mixed solution are presented in a ratio of 0.008M:0.1M:0.04M. The mixed solution was placed into a reactor.

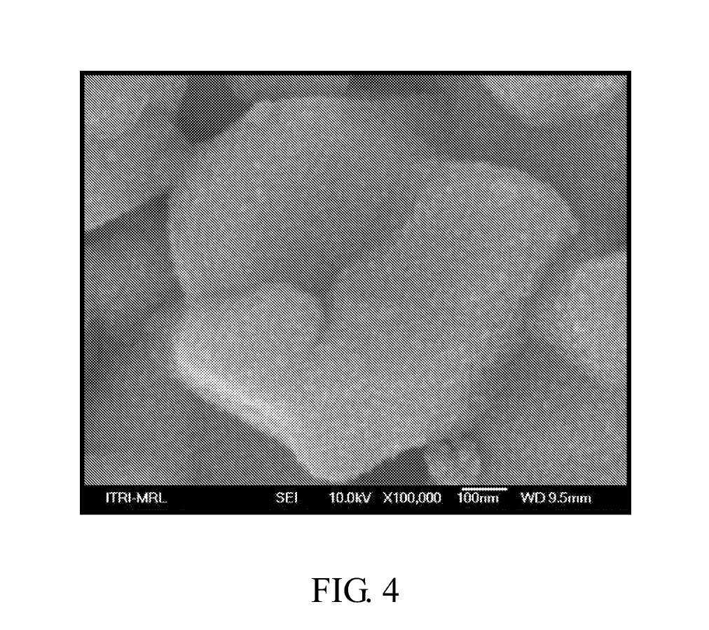

A printing CIGS layer was used as a substrate and was sunk into the mixed solution with its face down. The reactor was capped and heated in water bath at a temperature of 65° C. for 20 minutes to give a yellow indium (III) sulfide film. The indium (III) sulfide film formed on the CIGS layer had a coverage rate over 99%, and a thickness of about 20 nm-40 nm. FIG. 4 is a secondary electron image (SEI) diagram of the formed indium (III) sulfide film that formed.

In addition, the indium (III) sulfide film was used in a cell as a buffer layer, and the cell efficiency was measured. First, copper oxide, gallium oxide, and indium oxide were mixed in a specific ratio of Cu/(In+Ga)=0.85/(0.7+0.3), and the mixture was ball-milled to form nano-oxide particles. Next, the particles are coated onto a Mo/Cr/stainless steel substrate by scraper coating. After a H₂ reduction process and a selenized process, a CIGS absorbent film was obtained. Then, the indium (III) sulfide film was formed onto the CIGS absorbent film by the chemical bath deposition method as described above. Next, ZnO/AZO (doped ZnO) was sputtered onto the indium (III) sulfide film, and an electrode was formed thereon by electroplating. A cell unit was then obtained. The 2×2 cm² cell was divided into 9 cells (cells 1-9) with small surface area (0.141 cm²). A photoelectrical performance was measured by current-voltage and quantum efficiency.

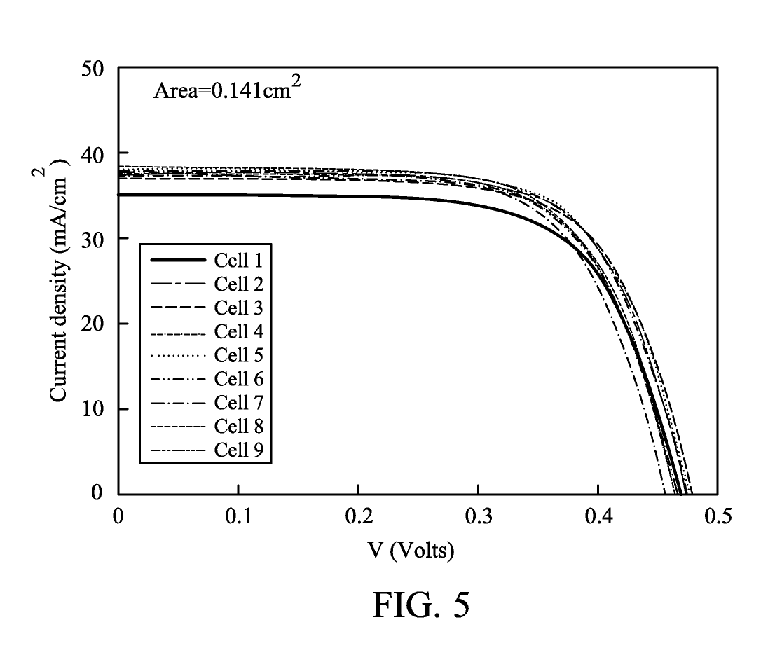

FIG. 5 illustrates a cell efficiency of the CIGS cell with the indium (III) sulfide film as the buffer layer. As shown in FIG. 5, the CIGS cell with the indium (III) sulfide film as the buffer layer had good cell efficiency (about 11%). Therefore, the formed indium (III) sulfide film can be used as a replacement of the conventional buffer layer to avoid the pollution of Cd.

### Example 4

First, tartaric acid was added into deionized water as a complexing agent, and the solution was stirred until the tartaric acid was completely dissolved. Next, In₂(SO₄)₃ was added into the solution as an indium ion source, and the solution was stirred until the In₂(SO₄)₃ was completely dissolved. Then, a SC(NH₂)(CH₃) solution was added into the solution described above and the mixed solution containing the complexing agents, the indium ions, and the hydrogen sulfide ions was stirred evenly. The complexing agent, the indium ions, and the hydrogen sulfide ions in the mixed solution are presented in a ratio of 0.008M:0.1M:0.04M. The mixed solution was placed into a reactor.

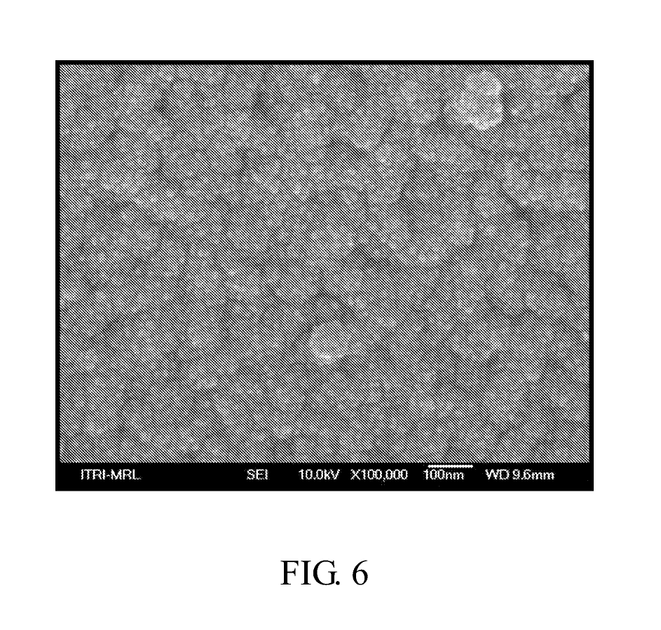

A printing CIGS layer was used as a substrate and was sunk into the mixed solution with its face down. The reactor was capped and heated in water bath at a temperature of 65° C. for 30 minutes to give a yellow indium (III) sulfide film. The indium (III) sulfide film formed on the CIGS layer had a coverage rate over 99%, and a thickness of about 50 nm-60 nm. Referring to FIG. 6 is a secondary electron image (SEI) diagram of the formed indium (III) sulfide film.

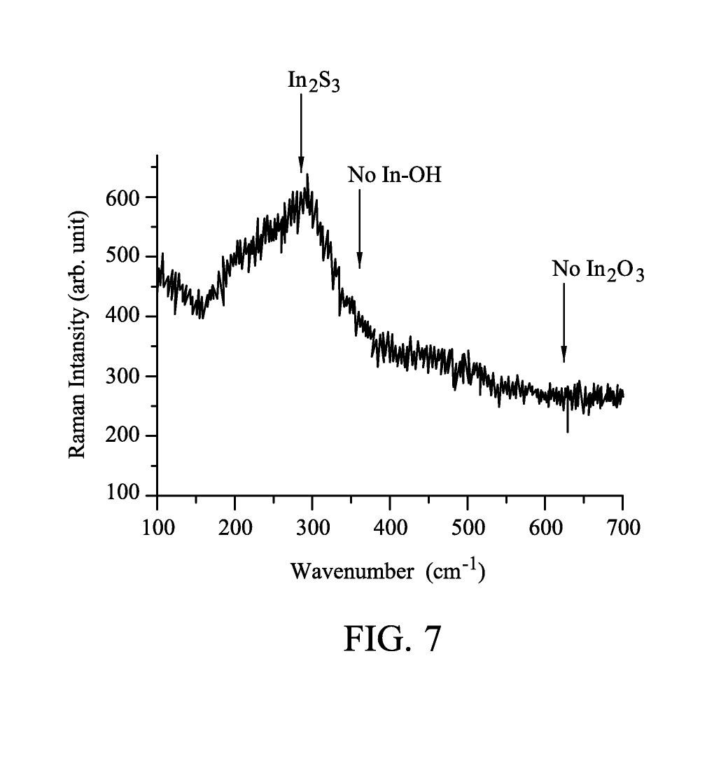

FIG. 7 is a Raman spectrum of the formed indium (III) sulfide film. In FIG. 7, there is a peak indicating indium (III) sulfide but no peak indicating indium hydroxide or indium oxide. That is, the formed indium (III) sulfide film had high purity and did not have contaminate such as indium hydroxide or indium oxide.

### Example 5

First, succinic acid was added into deionized water as a complexing agent, and the solution was stirred until the tartaric acid was completely dissolved. Next, In₂(SO₄)₃ was added into the solution as an indium ion source, and the solution was stirred until the In₂(SO₄)₃ was completely dissolved. Then, a SC(NH₂)(CH₃) solution was added into the solution described above and the mixed solution containing the complexing agents, the indium ions, and the hydrogen sulfide ions was stirred evenly. The complexing agent, the indium ions, and the hydrogen sulfide ions in the mixed solution are presented in a ratio of 0.008M:0.1M:0.04M. The mixed solution was placed into a reactor.

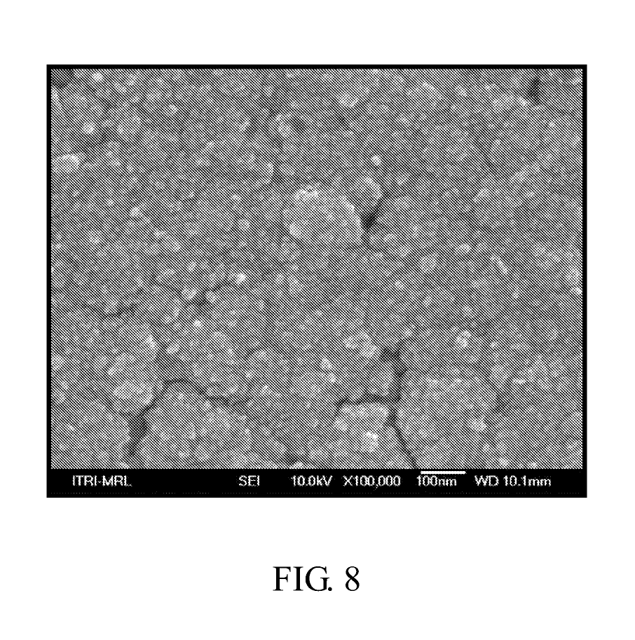

A Mo glass was used as a substrate and was sunk into the mixed solution with its face down. The reactor was capped and heated in water bath at a temperature of 65° C. for 30 minutes to give a yellow indium (III) sulfide film. The indium (III) sulfide film formed on the CIGS layer had a coverage rate over 99%, and a thickness of about 50 nm-60 nm. FIG. 8 is a secondary electron image (SEI) diagram of the formed indium (III) sulfide film that formed.

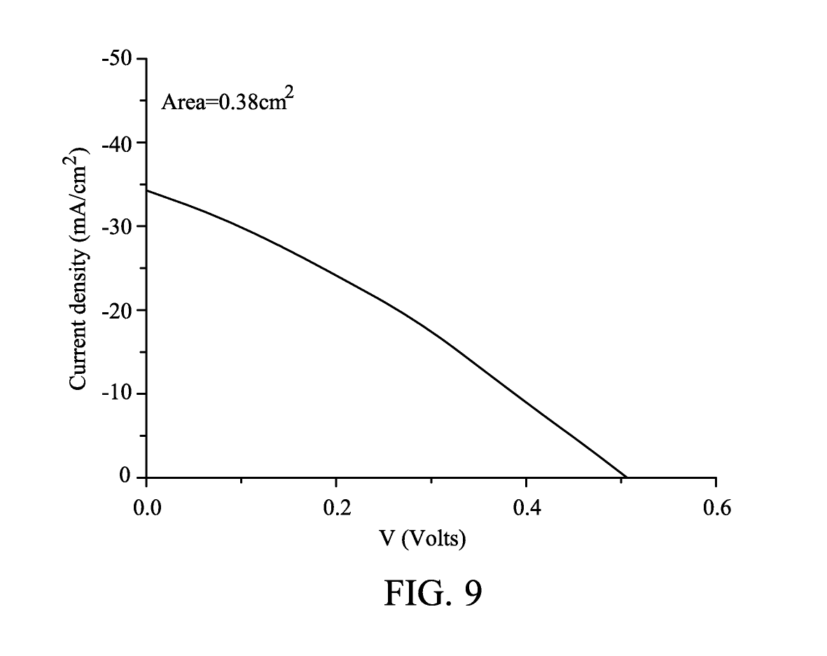

In addition, the indium (III) sulfide film was used in a CIGS cell as a buffer layer, and the cell efficiency was measured as described in Example 3. The 2×2 cm² cell was devided into 6 cells with small surface area (0.38 cm²). FIG. 9 illustrates a cell efficiency of the CIGS cell with the indium (III) sulfide film as the buffer layer. As shown in FIG. 9, the CIGS cell with the indium (III) sulfide film as the buffer layer had cell efficiency about 5.2%.

### Comparative Example 1

First, citric acid was added into deionized water as a complexing agent, and the solution was stirred until the tartaric acid was completely dissolved. Next, In₂(SO₄)₃ was added into the solution as an indium ion source, and the solution was stirred until the In₂(SO₄)₃ was completely dissolved. Then, a SC(NH₂)(CH₃) solution was added into the solution described above and the mixed solution containing the complexing agents, the indium ions, and the hydrogen sulfide ions was stirred evenly. The complexing agent, the indium ions, and the hydrogen sulfide ions in the mixed solution are presented in a ratio of 0.008M:0.1M:0.04M. The mixed solution was placed into a reactor.

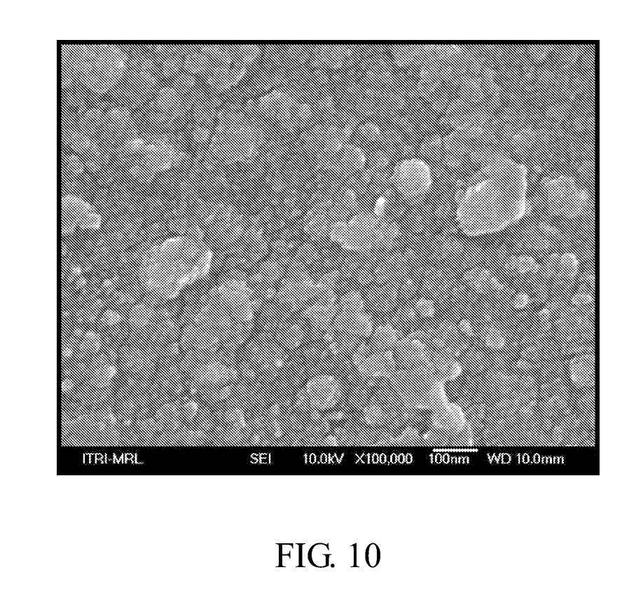

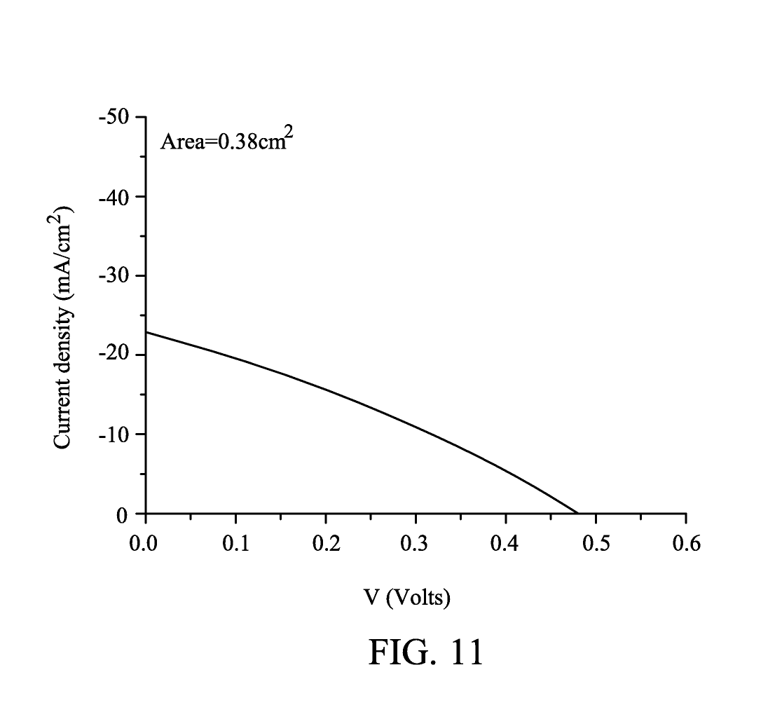

A Mo glass was used as a substrate and was sunk into the mixed solution with its face down. The reactor was capped and heated in water bath at a temperature of 65° C. for 30 minutes to give a yellow indium (III) sulfide film. The indium (III) sulfide film formed on the CIGS layer had a coverage rate over 99%, and a thickness of about 120 nm-130 nm. Referring to FIG. 10 is a secondary electron image (SEI) diagram of the formed indium (III) sulfide film. The formed indium (III) sulfide film was used in a sputtering CIGS cell as a buffer layer, and the cell efficiency was 3.4%, as shown in FIG. 11.

### Comparative Example 2

First, malonic acid was added into deionized water as a complexing agent, and the solution was stirred until the tartaric acid was completely dissolved. Next, In₂(SO₄)₃ was added into the solution as an indium ion source, and the solution was stirred until the In₂(SO₄)₃ was completely dissolved. Then, a SC(NH₂)(CH₃) solution was added into the solution described above and the mixed solution containing the complexing agents, the indium ions, and the hydrogen sulfide ions was stirred evenly. The complexing agent, the indium ions, and the hydrogen sulfide ions in the mixed solution are presented in a ratio of 0.008M:0.1M:0.04M. The mixed solution was placed into a reactor.

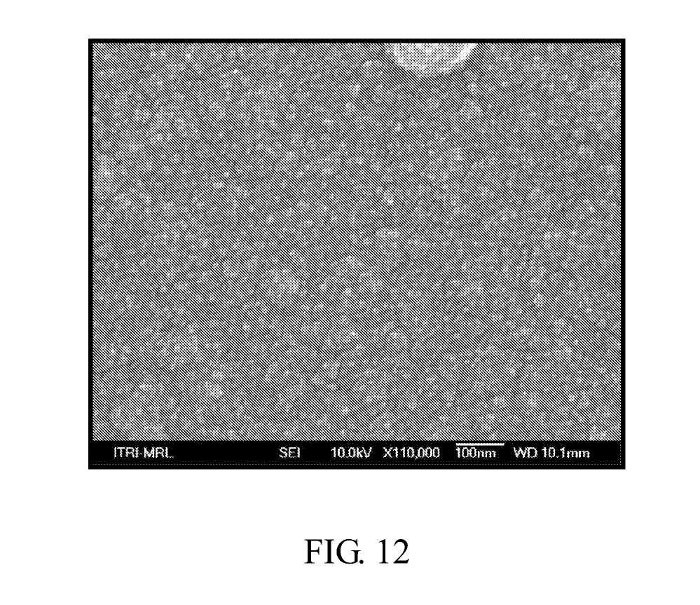

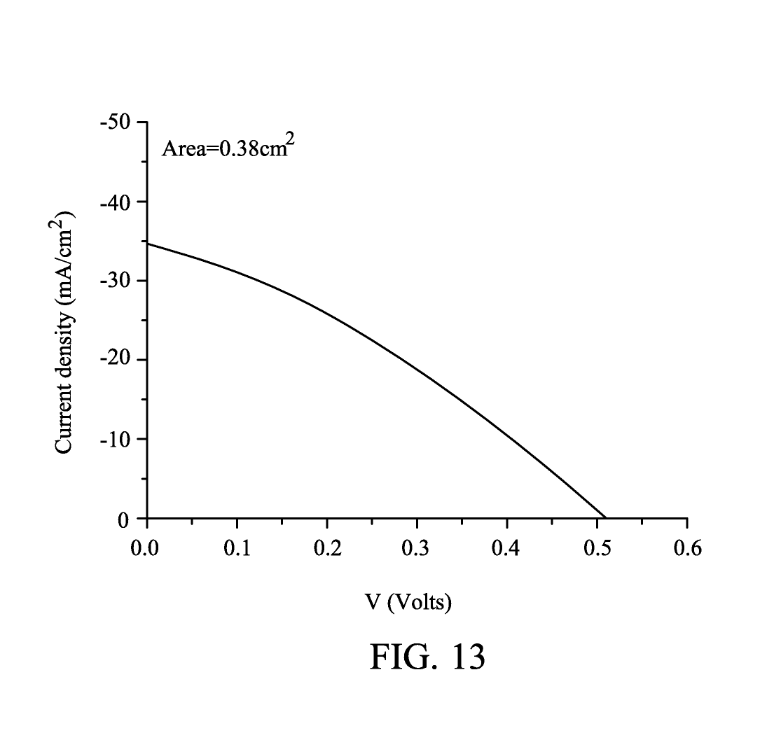

A Mo glass was used as a substrate and was sunk into the mixed solution with its face down. The reactor was capped and heated in water bath at a temperature of 65° C. for 30 minutes to give a yellow indium (III) sulfide film. The indium (III) sulfide film formed on the CIGS layer had a coverage rate over 99%, and a thickness of about 50 nm-60 nm. Referring to FIG. 12 is a secondary electron image (SEI) diagram of the formed indium (III) sulfide film. The formed indium (III) sulfide film was used in a sputtering CIGS cell as a buffer layer, and the cell efficiency was 5.6%, as shown in FIG. 13.

### Comparative Example 3

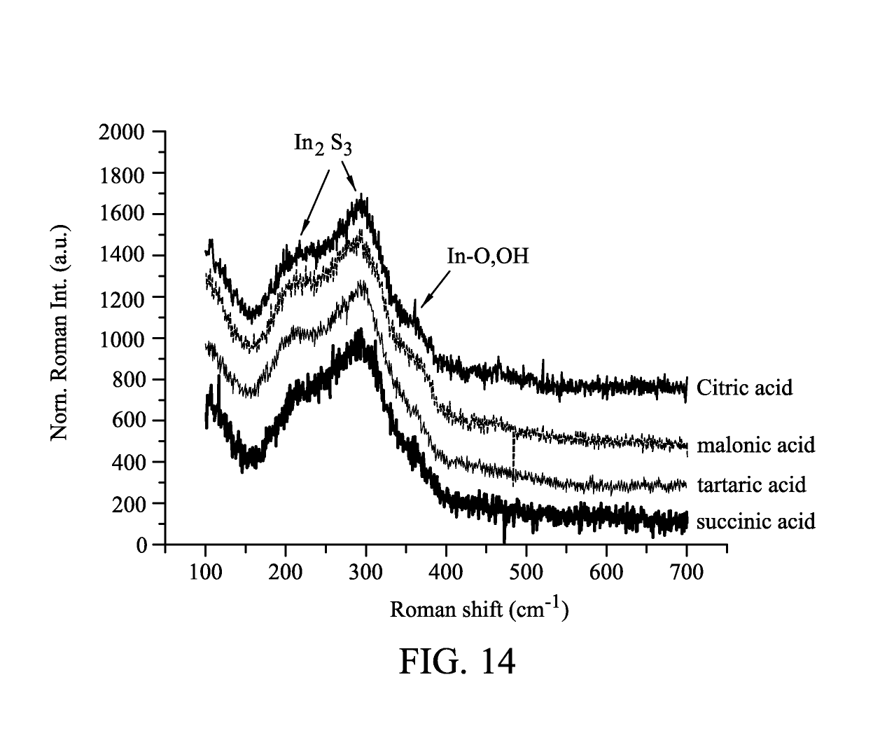

The Roman spectra of the indium (III) sulfide films formed in Examples 3 (tartaric acid was used as the complexing agent), Examples 4 (succinic acid was used as the complexing agent), Comparative Examples 1 (citric acid was used as the complexing agent), and Comparative Examples 2 (malonic acid was used as the complexing agent) are compared in FIG. 14. Referring to FIG. 14, there is only peak indicating indium (III) sulfide but no peak indicating indium hydroxide or indium oxide when the complexing agent used was tartaric acid or succinic acid. That is, the formed indium (III) sulfide film had high purity and did not have contaminate such as indium hydroxide or indium oxide. However, as shown in FIG. 14, there is a peak indicating indium hydroxide when the complexing agent used was citric acid or malonic acid. That is, the formed indium (III) sulfide film had contaminate such as indium hydroxide or indium oxide. The indium hydroxide in the indium (III) sulfide will affect the energy gap of the formed indium (III) sulfide film. The more the indium hydroxide is formed, the higher the energy gap is. Therefore, the energy gay of the formed indium (III) sulfide film may not match with the CIGS absorbent layer and may result in a heterointerface as a flaw of the structure. Thus, the formed cell, with lower transmittance and higher resistance, can not be performed in the best mode.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for forming an indium (III) sulfide film, comprising
providing a mixed solution containing a complexing agent, indium ions, and hydrogen sulfide ions; and
contacting the mixed solution with a substrate to form an indium (III) sulfide film thereon,
wherein the complexing agent has the following formula: 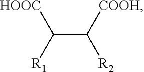
wherein each of R₁ and R₂ respectively is hydrogen or hydroxyl.

2. The method for forming an indium (III) sulfide film as claimed in claim 1, further comprising adding a metal salt containing indium to form the indium ions.

3. The method for forming an indium (III) sulfide film as claimed in claim 2, wherein the metal salt containing indium comprises indium (III) sulfate (In₂(SO₄)₃), indium trichloride (InCl₃), indium (III) acetate (In(C₂H₃O₂)₃), or any other salts that release indium ions when dissolved in water, or combinations thereof.

4. The method for forming an indium (III) sulfide film as claimed in claim 1, further comprising adding thioacetamide to form the hydrogen sulfide ions.

5. The method for forming an indium (III) sulfide film as claimed in claim 1, wherein the complexing agent comprises tartaric acid, succinic acid, or combinations thereof.

6. The method for forming an indium (III) sulfide film as claimed in claim 1, wherein the complexing agent, the indium ions, and the hydrogen sulfide ions in the mixed solution are presented in a ratio of 0.01M-0.5M:0.025M-0.1M:0.01M-1M.

7. The method for forming an indium (III) sulfide film as claimed in claim 1, wherein the step of contacting the mixed solution with a substrate to form an indium sulfide film thereon is performed at a temperature of 25° C. to 80° C.

8. The method for forming an indium (III) sulfide film as claimed in claim 1, wherein a pH value of the mixed solution is between 1 and 3.

9. The method for forming an indium (III) sulfide film as claimed in claim 1, wherein a thickness of the indium (III) sulfide film is between 20 nm and 100 nm.

10. The method for forming an indium (III) sulfide film as claimed in claim 1, wherein the substrate comprises a copper indium gallium diselenide (CIGS) layer, and the indium sulfide film is formed on the copper indium gallium diselenide layer.

11. The method for forming an indium (III) sulfide film as claimed in claim 10, wherein the substrate further comprises an electrode layer under the copper indium gallium diselenide layer.

12. The method for forming an indium (III) sulfide film as claimed in claim 11, wherein the electrode layer comprises molybdenum, gold, or any other conductive metal, or combinations thereof.
